(19) United States
(12) Patent Application Publication
(10) Pub. No.: US 2023/0296148 A1
(43) Pub. Date: Sep. 21, 2023

(54) ELASTOMER SEALING RING FOR AN IMPROVED SEALING SYSTEM OF AN ELECTRICALLY ACTUATABLE MOTOR-VEHICLE DISC BRAKE

(71) Applicant: Continental Automotive Technologies GmbH, Hannover (DE)

(72) Inventors: Thomas Heß, Seeheim-Jugenheim (DE); Dieter Füller, Nauheim (DE); Florian Sauer, Frankfurt am Main (DE); Willi Werner Zeig, Bensheim (DE)

(73) Assignee: Continental Automotive Technologies GmbH, Hannover (DE)

(21) Appl. No.: 18/040,923

(22) PCT Filed: Aug. 3, 2021
(86) PCT No.: PCT/DE2021/200101

§ 371 Date: Feb. 7, 2023

(30) Foreign Application Priority Data
Aug. 7, 2020 (DE) 10 2020 210 069.1

(51) Int. Cl. F16D 55/226; B60T 1/06

(52) U.S. Cl. CPC F16D 55/226; B60T 1/065; F16D 2125/08

(57) ABSTRACT

An elastomer sealing ring and to a sealing system for an electric motor vehicle disk brake, has an actuating element removeably mounted in a housing compartment. The sealing system has multilateral interfaces and the elastomer sealing ring including a bearing, in a sealing receptacle the elastomer sealing ring blocks at least one or more sealing gap(s) between a brake housing and the actuating element concentrically with respect to the actuating element and laterally next to a cavity. The elastomer sealing ring/sealing are suitable and intended for electrically actuatable motor vehicle disk brakes. The elastomer sealing ring has a partially symmetrical elastomer sealing ring cross section and in cooperation with interfaces, a gap seal adapted is made possible.

### CROSS REFERENCE TO RELATED APPLICATIONS

The present application is a National Stage Application under 35 U.S.C. § 371 of International Patent Application No. PCT/DE2021/200101 filed on Aug. 3, 2021, and claims priority from German Patent Application No. 10 2020 210 069.1 filed on Aug. 7, 2020, in the German Patent and Trademark Office, the disclosures of which are herein incorporated by reference in their entireties.

### TECHNICAL FIELD

The present invention relates to an elastomer sealing ring and to a sealing system for an electric motor vehicle disk brake which is actuatable by means of an actuator using an actuating mechanism. BACKGROUND

DE 197 32 168 C1 relates to a motor vehicle disk brake that can be actuated in combination electrically and mechanically (i.e. hydraulically) with an electric fixing device, wherein a rotationally driven threaded spindle of the actuator with an axis of rotation in the center of a hydraulic chamber in a brake housing is provided so as to be axially nondisplaceable, fixed, supported and rotatable relative thereto by means of a bearing in a housing base, and is in screw engagement with a threaded nut arranged for conjoint rotation and axially displaceable in the hydraulic chamber in order to act upon a disk brake pad with actuating force by means of rotational-translational converted actuation. The spindle passes through the housing base by means of a spindle bushing bore, i.e. emerges laterally from the hydraulic chamber. For the purpose of sealing the gap in the spindle bushing, a groove is made in the housing base immediately adjacent to a bearing back and a shaft seal which ensures the tightness of the hydraulic chamber is located in the groove.

A dynamically internally sealing rod sealing system of the type in question with a sealing ring fitted statically stationarily in the brake housing has to function durably and completely reliably and safely under the influence of all the complex braking operation effects, i.e. has to seal at least one sealing joint in an elastically reversibly compensating and quasi-hermetic manner. This applies both to the initial tightness of the system after all the components and systems have been assembled on the vehicle and during the operation of the vehicle. In this complex stress, the following are particularly problematic: external system effects of the stress spectrum, such as weathering, corrosion, peripheral effects and/or internal system effects of the brake stress spectrum, for example, additive superimposition of compression with (hydraulic) system pressure to be sealed, tribological system conditions, elastic material behavior, gap extrusion, elastic component deformation such as bending/buckling and/or component misalignment, for example aging, (partially oblique) wear and tear, tolerances, static, dynamic and hydraulically superimposed compressive stresses and the corresponding operating temperature window.

A sealing system for a spindle drive of an electrically actuatable motor vehicle disk brake, which in cooperation with modern motor vehicle applications as well as with modern electronic brake systems and/or brake functions which is adaptable and durable without fear of fatigue caused by overstressing, abrasive damage, chipping, cutting, gap extrusion or similar failure phenomena in an elastomer seal is desired.

### SUMMARY

An elastomer sealing ring, and a sealing system, for an electric motor vehicle disk brake has an actuating element mounted in a housing compartment. The sealing system has multilateral interfaces and the elastomer sealing ring, including a bearing, in a sealing receptacle the elastomer sealing ring blocks at least one or more sealing gap(s) between a brake housing and the actuating element concentrically with respect to the actuating element 4 and laterally next to a cavity. The elastomer sealing ring/sealing system are suitable and intended for electrically actuatable motor vehicle disk brakes. The elastomer sealing ring 1 which has a partially symmetrical elastomer sealing ring cross section, and in cooperation with interfaces, a gap seal adapted is made possible.

### BRIEF DESCRIPTION OF THE DRAWINGS

The present disclosure will become more fully understood from the detailed description and the accompanying drawings, wherein:

FIG. 1 shows a brake caliper of the floating caliper type equipped with parts of the actuator, rotational-translational converter, in section and on a reduced scale;

FIG. 2 shows an enlarged drawing excerpt with sealing interface, a rotational-translational transmission including an axial bearing unit and a thrust piece (hydraulic brake piston) according to FIG. 1;

FIG. 3 shows, in a half section, on an enlarged scale, part of an elastomer sealing ring;

FIG. 4 shows the elastomer sealing ring as in FIG. 3 including peripheral built-in parts (support ring->prevents gap extrusion, spindle bearing), but in a pre-assembly position, before the sealing ring is accommodated in a brake housing;

FIG. 5 shows detail E—the elastomer sealing ring as in FIG. 3 in its mounted position (installation space with inserted D-shaped elastomer sealing ring—almost no unfilled “clearances” in the region of the sealing gaps);

FIG. 6 shows detail E—as FIG. 5 does, only under hydraulic internal pressure stress;

FIG. 7 shows detail E, schematically the force flux distributed over a large area, i.e. distributed extensively, to peripherally adjacent components (support ring, radial bearing) as a result of hydraulic pressure application through the use of the elastomer sealing ring;

FIG. 8 shows schematically in section, on an enlarged scale, a schematic diagram of the installation space and with sealing gap clarification S; and

FIG. 9 shows, enlarged, primarily the head sector of an embodiment of the elastomer sealing ring for the purpose of clarifying a slope with mutually inclined pitched roof surfaces.

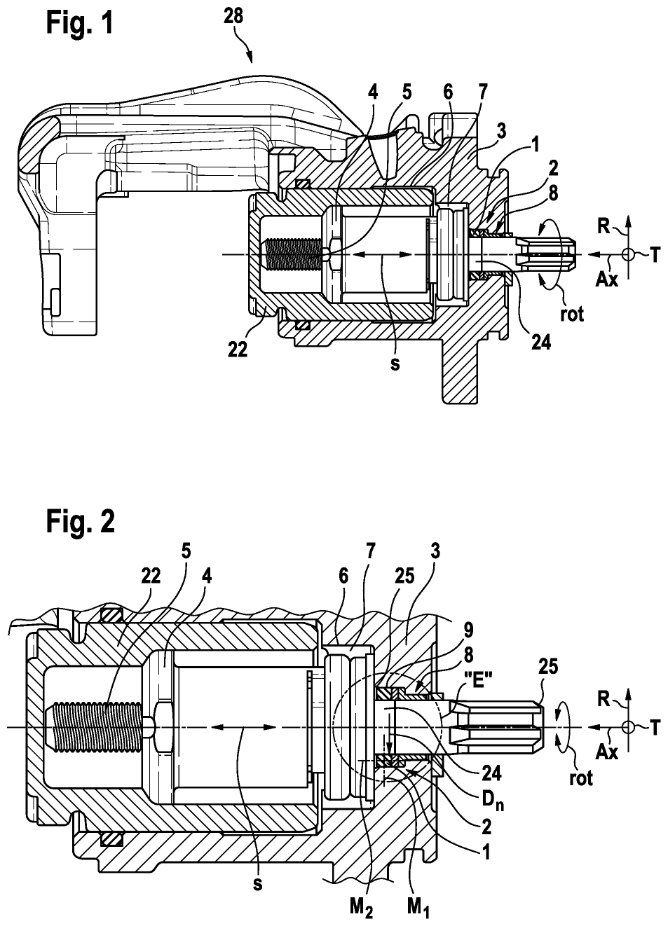

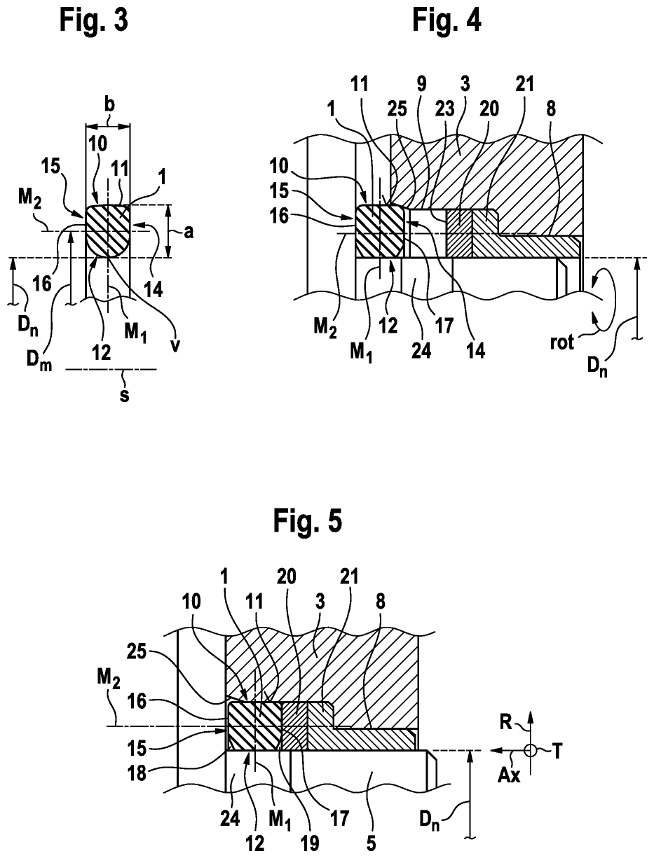

### DETAILED DESCRIPTION

An elastomer sealing ring 1 with a given nominal diameter Dn and with a partially symmetrical elastomer sealing ring cross section (always based on a relaxed, undeformed basic state) is presented for the first time in.

In this case, the elastomer sealing ring cross section is in principle arranged symmetrically in relation to a first reference axis M 1, which is directed radially with respect to an actuating axis/friction lining displacement axis s. In contrast, the elastomer sealing ring 1 is produced asymmetrically in relation to a second, axially directed reference axis M 2 (axial axis=parallel to the actuating axis S). The two reference axes M 1, M 2 are orthogonally perpendicular to each other and intersect (in the center of the cross section, that is to say, substantially centrally, i.e. very substantially in the centroid of the elastomer sealing ring cross section), and the shaping details basically refer to a stress-free, i.e. to a new, unconstrained, undeformed initial state of the elastomer sealing ring 1 in the ambient atmosphere, i.e. without an elastomer sealing ring 1 being subjected to hydraulic pressure phyd, and without an elastomer sealing ring 1 being clamped in a seal receptacle 9/multilateral system. Very generally, the outer contour of the elastomer sealing ring 1 is therefore congruent with its associated seal receptacle 9.

With a substantially homogeneous distribution of elasticity over its entire volume because of its particular structure and shaping, and together with a graduated sealing receptacle 9—i.e. placing at the working location, the elastomer sealing ring 1 allows a particularly economical and advantageous—namely gradually different and nevertheless balanced—elastic pressure and interface behavior in the region of its sealing areas, without unnecessarily large flexing or deformation work being required during operation under relative displacement and/or pressure and/or compression and/or internal hydraulic pressure, possibly in combination with pulsating pressure stress. The elastomer sealing ring 1 can be spared damage from nibbling or similar effects by its substantially congruent accommodation in a sealing receptacle 9 requiring/permitting substantially no flexing work.

Since each elastomer sealing ring 1 designed is allowed a defined, limited elastomer intrusion (reduced elastic working capacity) as a result of its novel special shaping, or as a result of its substantially congruent fitting into its correspondingly graduated sealing receptacle 9. A disk brake provided in a correspondingly reinforced way is suitable for giving a vehicle driver even particularly sporty, i.e. stable, brake actuation feedback because the internal elasticity of said disk brake is significantly reduced.

In one refinement, it is provided that a cylindrically circumferential, radially outer periphery of the radially compressed elastomer sealing ring 1 (head sector 10, static gap seal with respect to the brake housing 3), i.e. radially on the outside, is enabled to have a particularly stable, stationary bearing/arrangement in the cylindrical wall of its seal receptacle, with the sealing receptacle 9 also being substantially filled to this extent. In a further refinement, it is provided that the elastomer sealing ring 1 designed in is pressed on the outer circumference (head sector 10) with a predetermined elastic radial prestress (compression) into the maximum groove base diameter Dhmax of its seal receptacle 9 by the elastomer sealing ring outer diameter, measured in a relaxed state, being larger than the relevant maximum diameter in the groove base Dhmax of its seal receptacle 9. This enables a stable and durable planar support, in other words a very robust elastomer sealing ring allocation with minimized surface pressure in the region of a substantially statically stressed gap sealing interface, without the risk of the elastomer sealing ring 1 becoming detached. Since the elastomer sealing ring 1 with its given shaping and after its positioning in the head sector 10 (in the unstressed installation state) substantially completely fills the seal receptacle in this sector, accelerated brake venting behavior is also positively supported.

In an additional refinement of an additionally further improved elastomer sealing ring 1, the latter (such as in principle in its unloaded, undeformed state) is applied laterally rearwardly (back sector 14, on the housing support side, i.e. next to a spindle bearing 21 of the spindle bushing 8) snugly and flatly i.e. in a planar rearward manner to a seal receiving base 23. Consequently, the seal receptacle 9 is substantially completely filled in this back sector 14. Here, too, this results in a sector with a correspondingly reduced elastomer work capacity under operational stress. In other words, a yielding and deformation capacity of the sealing ring 1 under hydraulic pressure p_{hyd} is also limited to this extent because the seal receptacle 9 is in any case substantially completely filled by the volume of the elastomer sealing ring on the back sector side of the fitted elastomer sealing ring 1. This makes it possible for an improved elastomer sealing ring 1 to withstand high-pressure overloading, i.e. without being damaged. Nibbling damage caused as a result of pulsating pressure stress is therefore permanently eliminated, or at least significantly reduced, and the sealing system 2 consequently behaves in a particularly durable and robust manner. Ergo, the further developed design is very particularly recommended for use for actuators which, in addition or supplementary to purely mechanical actuation with a mechanical actuator, could also experience superimposed hydraulic internal pressure stress as a result of hydraulic high pressure in a cavity 7/pressure chamber.

In yet another structural refinement, diametrically opposite the head sector 10/head sector of the elastomer sealing ring 1, a foot sector 12 is micromachined for sealing a dynamically stressed sealing gap in the direction of a surface roughness which is structured in a defined and offset way and/or with particular concentricity and/or with fine definition. In this case, the seal bearing surface on the relatively movable spindle 5 may be for example cylindrical. Since, as a result, the relatively movable spindle 5 is mounted in the brake housing 3, for example in an axially fixed but relatively rotatable manner (cf. reversible direction of rotation in accordance with “rot” in the figure), the dynamically stressed sealing interface results in the foot sector 12 of the elastomer sealing ring 1, i.e. radially on the inside. A foot sector 12 of the elastomer sealing ring 1 is curved in principle in relation to said sealing bearing surface for the purpose of further developing the gap seal, i.e. in a circular arcuate manner or spherical in shape, as a result of which the inner circumference of the elastomer sealing ring cross section in a top view consequently to a certain extent has a cross section which can be described as curved pointing radially inward in a “D-shaped” manner (“hump”). The result is a contact pressure/surface pressure, adapted in a further developed, defined and modified way, of the elastomer sealing ring 1 in the foot sector 12. This is because, with a quasi-homogeneous and/or quasi-hydraulic pressure distribution in the elastomer sealing ring 1, the accordingly obtained surface pressure in the sealing gap of the head sector 10 is at any rate gradually reduced in comparison to the surface pressure obtained in the foot sector 12. In other words, the surface pressure on the elastomer sealing ring 1 is significantly higher radially on the inside than radially on the outside. An apex v of the arc/curvature 13 intersects with the radially directed reference axis M 2. Laterally to the side of the apex v between the seal receptacle 9 and the actuating element/spindle 5 there are two clearances 18,19, the reservoir/volume of which could be elastically and reversibly filled by the elastomer sealing ring 1 as a result of elastomer deformation/pressure at internal pressure phyd. The curvature/arc 13 can in principle be as desired, for example in the form of a sector of a circle radius, and with other types of geometrical arc or curvature shapings being possible. The curvature 13 which is guided by way of example convexly with respect to the spindle 5 in the foot sector 12 of the elastomer sealing ring 1 with a centered apex causes a centered concentrated support and permits a comparatively large amount of stabilizing clearance, which is provided for the elastic elastomer sealing ring deformation under high pressure stress. An accompanying effect is that this sealing gap between the curved D-shaped profile of the elastomer sealing ring and the cylindrical sealing bearing surface 24 of the spindle 5 forms two chambers located laterally with respect to the reference axis M 1, with the efficiency of the actuator improved by reduced drag or undesired inhibition of the spindle drive (deterioration in efficiency due to undesired friction) is improved.

In a further refinement of an embodiment, each elastomer sealing ring 1 has two flanks/wall sides 16, 17 which are arranged parallel to one another at a distance at least in the relaxed state and which each connect the foot sector 12 to the head sector 10. Substantially flat, smooth flanks/wall sides or substantially smooth, i.e. flat head sectors result in a full, flush joint/support on the facing seal receptacle.

One or more installation aids 25 for pressing the elastomer sealing ring 1 into the seal receptacle 9 are possible. The installation aid 25 can be present either on the elastomer sealing ring 1 and/or in the region of the seal receptacle 9 and/or on the spindle 5. Any combination is also possible. As an installation aid 25 on the sealing ring side, also recommends that there are no sharp corners or edges in the profile transitions between the head sector, walls and foot sector, but rather radii r, and therefore profile transitions are rounded off with a defined radius r. One or more insertion bevels and/or rounded corners with arcuate or circular rounded corners are possible as an installation aid 25 on the brake housing side. Rounded corners may be designed here as a radius projection or as a fillet.

It is possible for there to be an elastomer sealing ring with a basically “D-shaped” structure in cross section.

In this context, a motor vehicle disk brake produced may in principle be designed to be hydraulically and/or electromechanically actuatable. The actuator system can comprise at least one transmission including a rotational-translational converter, such as, for example, a spindle-nut screw drive, which may be configured with or without a ball filling. It is not entirely out of the question for there to be a configuration as a hydraulic-free by-wire brake.

The improved sealing system seals a spindle bushing between the actuator system and the interior of the housing in a brake housing and has to withstand all external influences of a stationary and rotating spindle (during the clamping and releasing process of the electric brake), a design-related inclined position of the spindle as a result of the brake caliper widening during the application, as well as the static and hydraulic pressure in the brake caliper.

### Brief Description of the Drawings

### DETAILED DESCRIPTION

In a brake (caliper) housing 3 of a motor vehicle disk brake 28, which is designed open in the manner of a bow or screw clamp, a substantially axially directed (through) bore 6 is used for the mounting, arranging and passage of an actuating means (spindle 5) of an actuator, and wherein the actuating means is suitable and intended to press a non-illustrated disk brake pad against a brake rotor using a rotational-translational motion conversion, for example via a threaded nut, a thrust piece, and/or a hydraulic brake piston.

According to an embodiment, there is a so-called “rod seal” statically accommodated radially on the outside of the housing in a seal receptacle 9 in connection with a circularly closed circumferential elastomer sealing ring 1. The seal receptacle 9/spindle bushing 8 is provided with an offset stepped profile (corner radii, i.e. rounded corners, broken edges and/or chamfers are possible) as part of the (through) bore 6 in the brake caliper housing 3. The elastomer sealing ring 1 fills the installation space provided in the seal receptacle 9 as a result of defined (predominantly radially directed) pressure (clamping). Installation space can be present as a radial groove in the brake housing 3, and wherein the radial groove is open in the direction radially inward toward the bore 6. The installation space (radial groove) is delimited by the given adjacent components. Interfaces to be filled elastically can be located adjacent between the periphery, i.e. outer diameter of the radial groove Dhmax, spindle diameter Dn, support ring, radial bearing and/or brake caliper housing 3, and sealing joint. In other words, a (joint) gap size S for all load cases and tolerance positions is substantially completely covered/blocked/filled by the elastic pressure of the elastomer sealing ring 1.

As can be seen, an elastomer sealing ring 1 substantially eliminates the remaining “clearances” 18,19, at least except for a few exceptions. Since the elastomer sealing ring 1—with its given shaping and with its positioning—fills the periphery/seal receptacle 9 substantially completely and without any undercuts, an accelerated brake venting behavior is obtained.

Owing to the contour of the elastomer sealing ring 1, which may be curved in a D shape, remaining clearances 18, 19 in the installation space are immediately reduced to a minimum. This can prevent massive damage (e.g. tearing, bursting or breaking out of the sealing ring material, nibbling, etc.). In this case, the D-curvature 13 can very basically be convex and/or concave as desired. As an alternative and/or in addition, it is possible to provide a curvature 13 consisting of a plurality of geometric (curved and/or rectilinear) pieces of a curvature contour of gradually different dimensions that are joined together, or any three-dimensional curve. In terms of manufacturing technology, a configuration appears to be preferable in the form of an assembled circular arc curvature that can be differentiated into any number of sectors (1-n different sectors) and that may also have other components, such as interspersed rectilinear sections, if necessary, and with, alternatively, other differently curved geometric arc or curvature shapings also being conceivable. As shown in the figure, a curvature 13, which is guided back simply in a convexly arcuate manner, in the foot sector 12 of the elastomer sealing ring 1 brings about, with its central apex v, a favorable—to a certain extent centrally concentrated —support under correspondingly concentrated elastomer pressure, and laterally permits a comparatively large clearance 18,19, which allows a receiving space for the purpose of elastic elastomer sealing ring deformation under superimposed high-pressure stress phyd. With such an elastomer sealing ring profiling, which may be radially inwardly convexly curved, formation of a reservoir tends to be assisted in the region of the lateral clearances 18,19, which may be present, for example, in the form of reservoir chambers filled with brake fluid, which helps to eliminate a drag effect and/or residual braking torques.

This behavior after damage due to overstressing, sealing ring extrusion or “nibbling” may occur in conjunction with conventional elastomer seals, because the latter, for example starting from a simple original O-ring shaping, have to be subjected to excessive pressure and/or overstressing in conjunction with a hydraulically superimposed compressive stress. This is because, in the event of pulsation and/or repeated load cycles or periodically recurring movements and/or increasing and decreasing elastic deformation of an elastic sealing ring material, a reversible elastic work capacity is finite, namely exhaustible, due to wear; or retraction, nibbling or similar damage to a conventionally structured shaft sealing ring occurs.

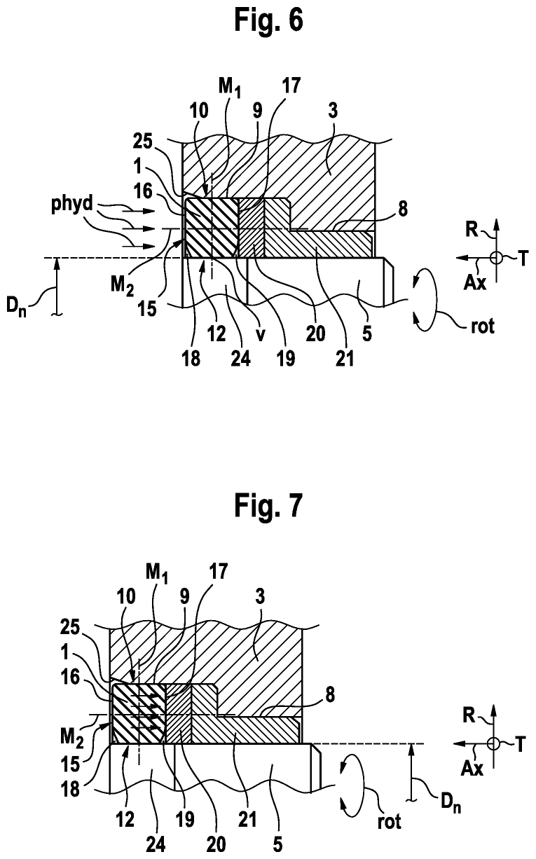

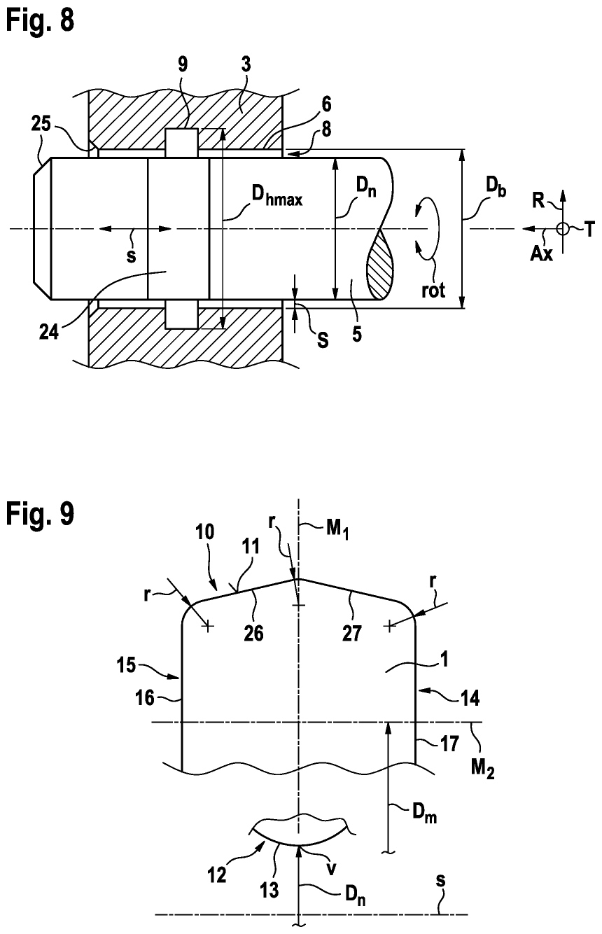

Accordingly, for the first time, a foot sector 12 may be present in such a way that it sits on the spindle diameter from radially outside with an inside diameter Dn, and wherein the elastomer sealing ring 1 with a reduced surface area under elastic prestressing (gradual elastic expansion of the elastomer sealing ring 1 through the spindle diameter+gradual radial compression due to the radial groove with Dhmax) is present, as is shown by way of example in FIG. 6. The radially inner surface pressure—i.e. the pressure—in the foot sector 12 is increased compared to the pressure in the head sector 10 (radial groove). The reduced planar support surface in the foot sector 12 enables an improved sealing function in conjunction with spindle inclination or brake caliper bending tendencies under very high loads. At the foot sector 12, the contour of the “D-shaped elastomer sealing ring 1” is designed in such a way that, on the one hand, as little “unfilled installation space” as possible is available and, on the other hand, a functionally necessary (theoretical) linear contact with the spindle is obtained.

In a further refinement of an embodiment, each elastomer sealing ring 1 has two flanks 16, 17 which are arranged substantially parallel to one another at least in the relaxed state and which connect the foot sector 12 to the head sector 10, and vice versa. Substantially flat, smooth flanks 16, 17 or substantially smooth, i.e. predominantly flat head sectors 10, bring about a full, flush joint, i.e. cooperation with the associated seal receptacle 9.

One or more installation aids for pressing of the elastomer sealing ring 1 into the seal receptacle 9 are possible. The installation aid(s)/insertion aid(s) 25 can be present on the elastomer sealing ring 1 itself and/or in the region of the seal receptacle 9 in the region of the bore 6 and/or in combination with one another. It can also be recommended to facilitate installation if the elastomer sealing ring 1 is configured with a bevel, inclined for example in the shape of a pitched roof, and/or is greased in a defined manner, for example on the head sector 10. The pitched roof surfaces 26, 27 can be tapered to a certain extent on the outer circumference, i.e. can be arranged alternately symmetrically inclined to one another in cross section, as can be seen in FIG. 9, and/or surfaces inclined as desired can be provided (e.g. by a pitched roof design that is tapered multiple times on both sides). Assistance is also present if this is present in the region of the seal receptacle 9, spindle 5 or periphery as a chamfer, inclined surface and/or possibly circumferential depression. As a further precaution on the sealing ring side—thus as an installation aid—there may be no sharp corners or edges in the circumferential profile transitions between the head sector 10, walls and foot sector 12, but that such profile transitions are rounded with a defined radius r. As an installation aid/insertion aid 25 on the brake housing side, one or more insertion bevels and/or rounded corners with arcuate or circular rounded corners and/or fillets are formed. All the rounded corners may be designed as a radius projection or as a fillet, without departing in principle.

An effect of the “D-shaped elastomer sealing ring design” can be seen from FIGS. 6 and 7, which makes it clear that a pressure transmitted to the respectively adjacent component—ergo to the support ring 20 and/or to the spindle bearing 21—is itself transmitted and initiated without damage even with hydraulically superimposed stress. This avoids misalignment, misplacement or punctiform damage to peripheral components.

Very basically, a sealing ring pressure after the sealing ring has been installed is measured at at least approximately between 5-25%, and wherein the formula for said pressure is:

$$\frac{D n - D h max}{D n} * 100 .$$

A percentage increase in elastomer sealing ring pressure is recommended for applications with a correspondingly increased system pressure superimposition in order to meet correspondingly increased sealing requirements.

Each elastomer sealing ring 1 may be completely soaked, for example impregnated, with brake fluid prior to its installation to facilitate installation. Purely by way of example, it is possible for each elastomer sealing ring to have a (diffused-in) brake fluid content of between at least approximately 0-10%.

1. An elastomer sealing ring for a sealing system of an actuator-actuated motor vehicle disk brake comprising:
an actuating mechanism in a brake housing movable relative thereto in at least one of a rotational and translational manner;
an actuating element is mounted in the brake housing movable relative thereto in an axially directed bore with an integral cavity;
a sealing system for the actuating mechanism with interfaces and
an elastomer sealing ring for the sealing system fitted into a sealing receptacle, wherein the elastomer sealing ring blocks at least one sealing gap substantially concentrically with respect to the actuating element and laterally next to the cavity; and
wherein the elastomer sealing ring has a partially symmetrical elastomer sealing ring cross section to permit a gap seal which is adapted in a multilaterally differently defined way in cooperation with peripheral interfaces.

2. The elastomer sealing ring as claimed in claim 1, wherein an elastomer sealing ring cross section is arranged symmetrically in relation to a first reference axi, which is directed radially with respect to an actuating axis, and in that the elastomer sealing ring cross section is produced asymmetrically in relation to a second reference axis, which is directed parallel to the actuating axis.

3. The elastomer sealing ring as claimed in claim 1, wherein a delimitation of an elastomer sealing ring cross section composed of a plurality of segment pieces is provided, and in that said delimiting segment pieces each composed of a plurality of rectilinear segments and/or of a plurality of arc segments, such as in particular of a plurality of curved segments, and/or of a plurality of circular arc segments are provided.

4. The elastomer sealing ring as claimed in claim 1, wherein the elastomer sealing ring has, radially on the outside, a head sector with a statically stressed sealing area.

5. The elastomer sealing ring as claimed in claim 4, wherein the head sector of the elastomer sealing ring comprises at least one inclined surface.

6. The elastomer sealing ring (1) as claimed in claim 5 wherein the head sector of the elastomer sealing ring has a plurality of roof surfaces inclined in relation to one another.

7. The elastomer sealing ring as claimed in claim 5, wherein the head sector of the elastomer sealing ring has a plurality of pitched roof surfaces.

8. The elastomer sealing ring as claimed in claim 2, wherein the head sector of the elastomer sealing ring a cylindrically circumferential flat wall bearing surface radially on the outside and peripherally.

9. The elastomer sealing ring as claimed in claim 1, wherein the elastomer sealing ring further comprises, radially on the inside, a foot sector with a dynamically stressed sealing area.

10. The elastomer sealing ring as claimed in claim 9, wherein the elastomer sealing ring is unevenly shaped in the foot sector with a curvature.

11. The elastomer sealing ring as claimed in claim 10, wherein the curvature is at least one of: convex, concave, crowned, arcuate, and curved in the shape of a circular arc.

12. The elastomer sealing ring as claimed in claim 1, wherein the elastomer sealing ring cross section is D-shaped.

13. The elastomer sealing ring as claimed in claim 1, wherein a hydraulic internal pressure increase in the cavity because of an increased elastic deformation of the elastomer sealing ring brings about an adaptive sealing effect, differently graduated relative to one other, via a differently adapted surface pressure in on at least one of a head sector, a foot sector, and a back sector of the elastomer sealing ring.

14. The elastomer sealing ring as claimed in claim 1, wherein the elastomer sealing ring is at least one of impregnated with brake fluid and the elastomer sealing ring has an embedded brake fluid content of at least 0-10%.

15. A sealing system for a motor vehicle disk brake comprising:
an elastomer sealing ring having an elastic contact support between the elastomer sealing ring and a sealing receptacle (9) such that an elastomer sealing ring surface pressure in a head sector of the elastomer sealing ring is lower than an elastomer sealing ring surface pressure in a foot sector of the elastomer sealing ring.

16. The sealing system as claimed in claim 15, wherein
a defined, limited radial elastic compression is provided for the sealing system as follows:
$$\frac{S}{D n} * 100 \geq 5 \%$$

17. The sealing system as claimed in claim 15, wherein a defined, limited elastic radial compression is provided for the sealing system as follows:
$$\frac{S}{D n} * 100 \leq 25 \%$$

18. The sealing system (2) as claimed claim 15, wherein a limited elastic compression of at least 5-25% is provided.

19. A motor vehicle disk brake with a sealing system comprising
at least one elastomer sealing ring;
an actuating mechanism in a brake housing movable relative thereto in at least one of a rotational and translational manner;
an actuating element is mounted in the brake housing movable relative thereto in an axially directed bore with an integral cavity;
a sealing system for the actuating mechanism with interfaces and
an elastomer sealing ring for the sealing system fitted into a sealing receptacle, wherein the elastomer sealing ring blocks at least one sealing gap substantially concentrically with respect to the actuating element and laterally next to the cavity; and
wherein the elastomer sealing ring has a partially symmetrical elastomer sealing ring cross section to permit a gap seal which is adapted in a multilaterally differently defined way in cooperation with peripheral interfaces.
